(19) United States
(12) Patent Application Publication
(10) Pub. No.: US 2026/0078232 A1
(43) Pub. Date: Mar. 19, 2026

(54) SEPARATION OF ELASTIC FIBERS IN TEXTILE MATERIALS

(71) Applicant: BASF SE, Ludwigshafen Am Rhein (DE)

(72) Inventors: Sina WITZEL, Ludwigshafen am Rhein (DE); Hannah Stephanie MANGOLD, Ludwigshafen am Rhein (DE); Indre THIEL, Ludwigshafen am Rhein (DE); Christian REIN, Ludwigshafen am Rhein (DE); Philipp Maximilian JUNG, Ludwigshafen am Rhein (DE); Achim STAMMER, Ludwigshafen am Rhein (DE); Tobias MAY, Ludwigshafen am Rhein (DE)

(21) Appl. No.: 19/108,762

(22) PCT Filed: Oct. 4, 2023
(86) PCT No.: PCT/EP2023/077374

§ 371 Date: Mar. 5, 2025

(30) Foreign Application Priority Data
Oct. 4, 2022 (EP) 22199617.6

(51) Int. Cl. C08J 11/08

(52) U.S. Cl. CPC C08J 11/08; C08J 2301/02; C08J 2375/04; C08J 2377/02; C08J 2377/06

(57) ABSTRACT

Disclosed herein is a method for separating a polymer blend, where the polymer blend includes (i) a polyamide and/or a cellulose based polymer, (ii) an elastic fiber: the method including: (a) providing the polymer blend and providing a solvent including gamma-valerolactone; and (b) contacting the polymer blend with the solvent including gamma-valerolactone at a temperature T1 of <170° C., thereby obtaining a solvent, which is enriched in dissolved elastic fiber, and a residue of the polymer blend, which is depleted of said elastic fiber and includes the polyamide and/or the cellulose based polymer.

Further disclosed herein is a polyamide and/or cellulose based polymer obtained from the method.

Additionally disclosed herein are a method of using the cellulose based polymer and a method of using the polyamide polymer.

The invention relates in a first aspect to a method for separating a polymer blend, wherein the polymer blend comprises (i) a polyamide and/or a cellulose based polymer, (ii) an elastic fiber; the method comprising: (a) providing the polymer blend and providing a solvent comprising gamma-valerolactone; (b) contacting the polymer blend with the solvent comprising gamma-valerolactone at a temperature T1 of <170° C., thereby obtaining a solvent, which is enriched in dissolved elastic fiber, and a residue of the polymer blend, which is depleted of said elastic fiber and comprises the polyamide or the cellulose based polymer. In a second aspect, the invention is related to a polyamide or cellulose based polymer obtained or obtainable from the method of the first aspect. A third aspect of the invention is related to the use of the cellulose based polymer of the second aspect and a fourth aspect of the invention is related to the use of the polyamide based polymer of the second aspect.

The demand for polymeric materials has drastically increased over the last decades. However, the poor biodegradability has led to large amounts of plastic waste, which is in Europe usually incinerated thereby loosing valuable materials and generating huge CO₂ emissions. Even worse is landfill due to the poor biodegradability. Polymeric materials have been used extensively in the textile sector, for example, as part of textiles such as clothes.

Especially mixed polymeric materials such as blends of natural polymers such as cotton or of synthetic polymers such as polyamide are often combined in textile applications with elastic fibers to comply with the customers' demands for elastic clothes. However, such mixed materials after end of their lifetime are hard to recycle.

An approach for recovery of polymeric materials includes the dissolving of the polymeric material. WO 2016/12755 A1 discloses an extraction of polyesters from packaging, wherein a first solvent is used for removal of colorants and a second solvent is used to dissolve the polyester. Chen et al. (Wenjun Chen, Yuechao Yang, Xue Lan, Baolong Zhang, Xiaogang Zhang and Tiancheng Mu in Green Chem., 2021, 23, 4065) describe a process for dissolution and accelerated alkaline hydrolysis of PET. However, these methods are limited in application, especially when it comes to recovery of polyesters from polymer blends comprising the respective polyester only as one component among a plurality of other materials.

Regarding textile materials, WO 2013/032408 A1 discloses a method for removal of spandex from polyamide elastomeric fabrics, comprising thermal treatment and washing of degraded spandex using solvents. WO 2022/115602 A1 describes a method for separation of blended textile material or a mixture of textile in order to get rid of an undesired polymer. However, these methods for separation/removal of elastic fibers and/or undesired polymers are always associated with the use of hazardous solvents.

The object underlying the present invention was thus the provision of an improved process, which enables a simple separation of elastic fibers out of a polymer blend comprising polyamide or a cellulose based polymer, which also enables a good recovery of the polyamide based polymer or of the cellulose based polymer, and which uses a non-hazardous solvent.

1^{st} aspect—process—method for separating a polymer blend

In a first aspect, the invention relates to a method for separating a polymer blend, wherein the polymer blend comprises
(i) a polyamide and/or a cellulose based polymer,
(ii) an elastic fiber;
the method comprising:
(a) providing the polymer blend and providing a solvent comprising gamma-valerolactone;
(b) contacting the polymer blend with the solvent comprising gamma-valerolactone at a temperature T1 of <170° C., thereby obtaining a solvent, which is enriched in dissolved elastic fiber, and a residue of the polymer blend, which is depleted of said elastic fiber and comprises the polyamide and/or the cellulose based polymer.

Gamma-valerolactone (C₅H₈O₂; IUPAC: 5-methyloxolan-2-one, abbreviation: GVL) is obtainable from carbohydrate-based biomasses, for example, it is readily obtained from sugar, and is thus a “green” solvent. It had so far only been described at the outmost as being able to dissolve single polymeric materials. It has now been surprisingly found, that using a solvent comprising GVL in the above-described method for separation of a polymer blend comprising polyamide based polymer and elastic fibers or cellulose based polymer and elastic fibers resulted in recovery of the polyamide based polymer or cellulose based polymer in good yields and purities. Elastic fibers could be effectively removed from the polymer blend without harming the polyamide based polymer or cellulose based polymer, which opens a great field for the re-use of the reobtained polyamide based polymer or cellulose based polymer.

A “polymer blend” means a combination of at least one polymer with at least one further component, which is at least another polymer, these components combined with each other in any suitable way. For example, in case of at least two polymers, the polymers are intermixed, or one or more polymer(s) are embedded in and/or interwoven with one or more other polymer(s), or the polymers are aligned in separate layers, as well as hybrid forms of these combinations. For example, a polymer blend is a textile, which comprises elastic fibers and polyamide (PA) or a natural polymer such as cotton, viscose and/or linen and optionally one or more filler(s) and optionally one or more further polymers, such as, for example, polyacrylonitrile. A “filler” is, for example, glass fiber, coal fiber, carbon black, inorganic salt (for example, talc, disodium carbonate), adhesive, thickener, antifoam agent, finishing agent (for example water/oil/stain repel-lent, flame retardant, anticrease agent, biocide), binder, surfactant (for example, softener, scouring agent, antistatic agent), desizing agent, bleaching agent, oxidant, UV filter, emulsionant, fixing agent, washing dispersant, profiling agent. These components are known to the skilled person. In some preferred embodiments, the invention relates to a method for separating a polymer blend, wherein the polymer blend comprises
(i) a polyamide and/or a cellulose based polymer,
(ii) an elastic fiber;
the method comprising:
(a) providing the polymer blend and providing a solvent comprising gamma-valerolactone;
(b) contacting the polymer blend with the solvent comprising gamma-valerolactone at a temperature T1 of <170° C., thereby obtaining a solvent, which is enriched in dissolved elastic fiber, and a residue of the polymer blend, which is depleted of said elastic fiber and comprises the polyamide or the cellulose based polymer. In some preferred embodiments, the polymer blend comprises (i) a polyamide or a cellulose based polymer, and (ii) an elastic fiber. In these embodiments, the invention is related to a method for separating a polymer blend, wherein the polymer blend comprises
(i) a polyamide or a cellulose based polymer,
(ii) an elastic fiber;
the method comprising:
(a) providing the polymer blend and providing a solvent comprising gamma-valerolactone;
(b) contacting the polymer blend with the solvent comprising gamma-valerolactone at a temperature T1 of <170° C., thereby obtaining a solvent, which is enriched in dissolved elastic fiber, and a residue of the polymer blend, which is depleted of said elastic fiber and comprises the polyamide or the cellulose based polymer.

“Contacting” in step (b) preferably means that the polymer blend is at least partially immersed in the solvent. Preferably, the polymer blend is at least partially immersed in the solvent in that at least 60%, more preferably at least 70%, more preferably at least 80%, more preferably at least 90%, more preferably at least 95%, more preferably at least 99% of the polymer blend surface are in contact with the solvent, based on the total surface of the polymer blend being 100%. Generally, no specific restrictions exist regarding the conditions under which the contacting in (b) takes place provided that an efficient dissolution of the elastic fiber takes place. In step (b), the elastic fiber is presumably not only dissolved, but furthermore at least partially degraded.

In some preferred embodiments of the method for separating a polymer blend, the elastic fiber of (ii) comprises one or more polyurethane based elastic fiber(s), wherein more preferably at least 40 weight-%, more preferably at least 45 weight-%, more preferably at least 50 weight-%, more preferably at least 55 weight-%, more preferably at least 60 weight-%, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-%, of the elastic fiber are a polyurethane based elastic fiber, each based on the total weight of the elastic fiber being 100 weight-%. “A polyurethane based elastic fiber” comprises one or more polyurethane based elastic fiber(s).

“Enriched in dissolved elastic fiber” regarding the solvent obtained in (b) means that the elastic fiber of (ii) was partially or completely removed from the polymer blend and became dissolved in the solvent, preferably at least 60 weight-%, more preferably at least 70 weight-%, more preferably at least 80 weight-%, more preferably at least 90 weight-%, more preferably at least 95 weight-%, more preferably at least 98 weight-%, more preferably at least 99 weight-%, of the elastic fiber of (ii) were removed from the polymer blend and became dissolved in the solvent, each based on the total weight of the elastic fiber of (ii) being 100 weight-%. “Depleted of said elastic fiber” with respect to the residue of the polymer blend obtained in (b), which comprises the polyamide or the cellulose based polymer, means that elastic fiber of (ii) was partially or completely removed from the polymer blend and became dissolved in the solvent. Thus, the residue of the polymer blend obtained in (b) comprises, in comparison to the initially provided polymer blend preferably at the outmost 40 weight-%, more preferably at the outmost 30 weight-%, more preferably at the outmost 20 weight-%, more preferably at the outmost 10 weight-%, more preferably at the outmost 5 weight-%, more preferably at the outmost 2 weight-%, more preferably at the outmost 1 weight-%, of the elastic fiber(s) initially contained in the provided polymer blend, each based on the total weight of the elastic fiber(s) initially contained in the provided polymer blend being 100 weight-%. In preferred embodiments where the elastic fiber of (ii) comprises one or more polyurethane based elastic fiber(s), the respective percentage values indicated above apply as well. For example, if at least 90 weight-% of elastic fiber of (ii) are polyurethane based elastic fiber(s) and at least 90 weight-% of the elastic fiber of (ii) were removed from the polymer blend and became dissolved in the solvent, this means that at least 90 weight-% of these 90 weight-% are removed from the polymer blend.

In some alternatively preferred embodiments of the method for separating a polymer blend, the elastic fiber of (ii) comprises one or more polyester based elastic fiber(s), wherein more preferably at least 40 weight-%, more preferably at least 45 weight-%, more preferably at least 50 weight-%, more preferably at least 55 weight-%, more preferably at least 60 weight-%, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-%, of the elastic fiber are a polyester based elastic fiber, each based on the total weight of the elastic fiber being 100 weight-%.

In some alternatively preferred embodiments of the method for separating a polymer blend, the elastic fiber of (ii) is a mixture of one or more polyurethane based elastic fiber(s), and one or more polyester based elastic fiber(s), wherein more preferably at least 40 weight-%, more preferably at least 45 weight-%, more preferably at least 50 weight-%, more preferably at least 55 weight-%, more preferably at least 60 weight-%, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-%, of the elastic fiber are a mixture of one or more polyurethane based elastic fiber(s), and one or more polyester based elastic fiber(s), each based on the total weight of the elastic fiber being 100 weight-%. In some further alternatively preferred embodiments, preferably at least 40 weight-%, more preferably at least 45 weight-%, more preferably at least 50 weight-%, more preferably at least 55 weight-%, more preferably at least 60 weight-%, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-% of the mixture of one or more polyurethane based elastic fiber(s) and one or more polyester based elastic fiber(s) are one or more polyurethane based elastic fiber(s), each based on the total weight of the mixture being 100 weight-%.

For these alternatively preferred embodiments “enriched in dissolved elastic fiber” regarding the solvent obtained in (b) means that elastic fiber of (ii), preferably the mixture of one or more polyurethane based elastic fiber(s), and one or more polyester based elastic fiber(s), was partially or completely removed from the polymer blend and became dissolved in the solvent, preferably at least 60 weight-%, more preferably at least 70 weight-%, more preferably at least 80 weight-%, more preferably at least 90 weight-%, more preferably at least 95 weight-%, more preferably at least 98 weight-%, more preferably at least 99 weight-%, of the mixture of one or more polyurethane based elastic fiber(s), and one or more polyester based elastic fiber(s), were removed from the polymer blend and became dissolved in the solvent, each based on the total weight of the mixture of one or more polyurethane based elastic fiber(s), and one or more polyester based elastic fiber(s) contained in the elastic fiber, being 100 weight-%. “Depleted of said elastic fiber” with respect to the residue of the polymer blend obtained in (b), which comprises the polyamide or the cellulose based polymer, means that elastic fiber of (ii), preferably the mixture of one or more polyurethane based elastic fiber(s), and one or more polyester based elastic fiber(s), more preferably at least polyurethane based elastic fiber(s), was partially or completely removed from the polymer blend and became dissolved in the solvent. Thus, the residue of the polymer blend obtained in (b) comprises, in comparison to the initially provided polymer blend preferably at the outmost 40 weight-%, more preferably at the outmost 30 weight-%, more preferably at the outmost 20 weight-%, more preferably at the outmost 10 weight-%, more preferably at the outmost 5 weight-%, more preferably at the outmost 2 weight-%, more preferably at the outmost 1 weight-%, of the mixture of one or more polyurethane based elastic fiber(s), and one or more polyester based elastic fiber(s) initially contained in the provided polymer blend, each based on the total weight of the mixture of one or more polyurethane based elastic fiber(s), and one or more polyester based elastic fiber(s) contained in the elastic fiber initially contained in the provided polymer blend being 100 weight-%.

The polyurethane based elastic fiber(s) is/are preferably (block) copolymers based on polyurethane. A (block) copolymer based on polyurethane is preferably a (block) copolymer of polyurethane and one or more polyether(s) selected from the group consisting of polyethylene glycol, polytetrahydrofurane, a copolymer of 2-methyl-tetrahydrofurane and tetrahydrofurane, and a copolymer of 3-methyl-tetrahydrofurane and tetrahydrofurane, wherein the (block) copolymer based on polyurethane is more preferably a (block) copolymer of polyurethane and polyethylene glycol or a (block) copolymer of polyurethane and polytetrahydrofurane, wherein more preferably in each of these (block) copolymers of polyurethane, the polyurethane content is at least 85 weight-%, based on the total weight of the (block) copolymer being 100 weight-%. The expression “(block) copolymer” means copolymer and blockcopolymer, wherein blockcopolymer is preferred. (Block) copolymers of polyurethane with one or more polyether(s) selected from the group consisting of polyethylene glycol, polytetrahydrofurane, a copolymer of 2-methyl-tetrahydrofurane and tetrahydrofurane, a copolymer of 3-methyl-tetrahydrofurane and tetrahydrofurane, especially when the polyurethane content is at least 85 weight-% based on the total weight of the (block) copolymer being 100 weight-%, are also called by generic names such as “spandex”, “elastan (e)”, “elastano”, “elastam”, “elastaan” or “lycra”. Brand names include also “Lycra”, “Elaspan”, “Acepora”, “Creora”, “INVIYA”, “ROICA”, “Dorlastan”, “Linel” and “ESPA”. A polyester based elastic fiber is preferably a poly(trimethylene terephthalate) (PTT) copolymer, wherein the poly(trimethylene terephthalate) copolymer is more preferably selected from the group of copolyesters synthesized from 2 or more reactants, each reactant having two functional groups capable of forming ester groups. For example, a poly(trimethylene terephthalate) copolymer may be prepared by reacting 1,3-propanediol and terephthalic acid, and optionally one or more comonomers selected from the group consisting of linear aliphatic dicarboxylic acids having 4 to 12 carbon atoms, cyclic aliphatic dicarboxylic acids having 4 to 12 carbon atoms, branched aliphatic dicarboxylic acids having 4 to 12 carbon atoms (such as butanedioic acid, pentanedioic acid, hexanedioic acid, azelaic acid, sebacic acid, dodecanedioic acid, 1,4-cyclo-hexanedicarboxylic acid, or ester-forming equivalents thereof), aromatic dicarboxylic acids other than terephthalic acid having 8 to 12 carbon atoms (such as phthalic acid, isophthalic acid or 2,6-naphthalenedicarboxylic acid); linear diols other than 1,3-propanediol having 2 to 8 carbon atoms, cyclic diols having 2 to 8 carbon atoms, and branched aliphatic diols having 2 to 8 carbon atoms (such as ethanediol, 1,2-propanediol, 1,4-butanediol, hexamethylene glycol, 3-me-thyl-1,5-pentanediol, 2,2-dimethyl-1,3-propanediol, 2-methyl-1,3-propanediol, cyclohexane di-methanol or 1,4-cyclohexanediol), aliphatic ether glycols having 4 to 10 carbon atoms and aromatic ether glycols having 4 to 10 carbon atoms (such as hydroquinone bis(2-hydroxyethyl) ether). Alternatively, a poly(trimethylene terephthalate) copolymer may be prepared from a poly(ethylene ether) glycol having a molecular weight below 460 g/mol, such as diethylene ether glycol, methoxypolyalkylene glycol, diethylene glycol, and polyethylene glycol. The comonomer is present in the copolymer in the range of from 0.5 to 30 mol %, preferably in the range of from 0.5 to 20 mol %. A generic name for a poly(trimethylene terephthalate) (PTT) copolymer is “Sorona”, wherein Sorona is in some embodiments a copolymer of 1,3-propane diol (preferably obtained by formation) and terephthalic acid (TPA) or dimethyl terephthalate (DMT), wherein preferably in the range of from 20 to 50 weight-%, more preferably in the range of from 30 to 40 weight-% of the copolymer are based on 1,3-propane diol, more preferably 1,3-propane diol obtained from renewable resources.

In some preferred embodiments of the method for separating a polymer blend, the solvent comprising gamma-valerolactone comprises gamma-valerolactone and optionally one or more solvent(s) selected from the group consisting of water and organic solvents having a log K_{OW} in the range of from −1.6 to +1.6, preferably selected from the group consisting of water, C5 to C12 alkane, aliphatic C1 to C10 alcohol, C3 to C10 ketone, C2 to C10 cyclic ketone, HO—[C1 to C10 alkyl-O—]ₙ—H, with n being an integer in the range of from 2 to 1000, C1 to C10 alkyl-O—C3 to C10 alkyl ether, C3 to C10 cyclic ether, optionally substituted with one or more C1 to C6 alkyl group(s), C6 to C10 aromatic hydrocarbon, optionally substituted with one or more C1 to C6 alkyl group(s), C2 to C10 aliphatic ester, C8 to C11 aromatic ester, C5 to C10 cyclic carboxylic ester (lactone), C3 to C12 amide, preferably R¹R²N—C(═O)—R³, wherein R¹, R² are independently a C1 to C4 alkyl group and R³ is selected from the group consisting of C1 to C9 alkyl group, C1 to C10 ester group and C1 to C6 ether group, C3 to C6 lactame, optionally substituted with one or more substituent selected from C1 to C6 alkyl group, C1 to C6 ester group and C1 to C6 ether group, and C5 imidazolidine, optionally substituted with one or more C1 to C6 alkyl group(s), C5 to C7 imidazolidone, optionally substituted with one or more C1 to C6 alkyl group(s).

Suitable solvents are known to the skilled person, as well as the decadic logarithm of the octanol-water partition coefficient (log K_{OW}). The octanol-water partition coefficient K_{OW} of a given compound is defined as the ratio of said compound's chemical concentration in the octanol phase relative to said compound's chemical concentration in the aqueous phase in a two-phase system of 1-octanol and water at a temperature of 25° C. (298 K). Methods to determine the octanol-water partition coefficient K_{OW} of a given compound are known to the skilled person. For example, the octanol-water partition coefficient K_{OW} of a given compound is determined using the shake-flask method which consists of dissolving the compound in a volume of high-purity 1-octanol and deionized water (pre-mixed and calibrated for at least 24 h) and measuring the concentration of the compound in each the 1-octanol phase and the water phase by a sufficiently exact method, preferably via UV/VIS spectroscopy. This method is described in the OECD Guideline for the testing of chemicals, number 107, adopted on Jul. 27, 1995. Values of K_{OW} for a plurality of substances are known and are easy to be found, for example, in the Dortmund Database (DDB, cf. http://www.ddbst.com/ddb-search).

Regarding suitable solvents, for example, an aliphatic C1 to C10 alcohol is preferably a C1 to C6 monool, more preferably one or more selected from the group consisting of methanol, ethanol and butanol. A C3 to C10 ketone is preferably acetone or methylethyl ketone or a mixture of acetone and methylethyl ketone. A C2 to C10 cyclic ketone is preferably cyclohexanone. A C3 to C10 cyclic ether optionally substituted with one or more C1 to C3 alkyl group(s) is preferably tetrahydrofuran or 2-methyltetrahydrofuran or a mixture of tetrahydrofuran and 2-methyltetrahydrofuran. A C6 to C10 aromatic hydrocarbon, optionally substituted with one or more C1 to C3 alkyl group(s) is preferably one or more selected from the group consisting of benzene, toluene, ethylbenzene, xylene (o or p) and mesitylene. A C1 to C10 ester is preferably one or more selected from the group consisting of esters of a C1 to C6 aliphatic monol with a C2 to C5 aliphatic acid. A C5 to C10 cyclic carboxylic ester (lactone) is preferably one or more selected from the group consisting of delta-valerolactone, methylated γ-butyrolactone, ethylated γ-butyrolactone, propylated γ-butyrolactone, and β-propiolactone. A C3 to C6 lactame, optionally substituted with one or more C1 to C3 alkyl group(s), is preferably selected from the group consisting of 2-pyrrolidone, 3-pyrrolidone and mixtures of 2-pyrrolidone, 3-pyrrolidone, each optionally substituted with one or more C1 to C3 alkyl group(s), preferably at the nitrogen atom, more preferably N-methyl-2-pyrollidone. An imidazolidone, optionally substituted with one or more C1 to C3 alkyl group(s) is preferably 1,3-dimethyl-2-imidazolidinone.

In some preferred embodiments of the method for separating a polymer blend, at least 1 weight-%, more preferably at least 5 weight-%, more preferably at least 10 weight-%, more preferably at least 20 weight-%, more preferably at least 30 weight-%, more preferably at least 40 weight-%, more preferably at least 50 weight-%, more preferably at least 80 weight-%, more preferably at least 90 weight-%, more preferably at least 95 weight-%, more preferably at least 99 weight-% of the solvent consists of gamma-valerolactone.

In some preferred embodiments of the method for separating a polymer blend, the polyamide is selected from the group consisting of polyamide 6, polyamide 6.6 and mixtures of polyamide 6 and polyamide 6.6. In some preferred embodiments of the method for separating a polymer blend, the cellulose based polymer is selected from the group consisting of natural cellulose based polymer, synthetic cellulose based polymer and mixtures of one or more natural cellulose based polymer(s) and one or more synthetic cellulose based polymer(s), wherein a natural cellulose based polymer is preferably selected from the group consisting of cotton, cellulose, lignin, linen, viscose and mixtures of two or more thereof and wherein a synthetic cellulose based polymer is preferably viscose, wherein the cellulose based polymer preferably comprises at least cotton, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-% of the cellulose based polymer are cotton, based on the total weight of the cellulose based polymer being 100 weight-%, more preferably the cellulose based polymer is cotton.

In some preferred embodiments of the method for separating a polymer blend, the contacting in (b) is done with a in mass based ratio polymer blend: solvent provided in (a) in the range of 1:1 to 1:100, preferably in the range of from 1:1 to 1:50, more preferably in the range of from 1:1 to 1:10.

In some preferred embodiments of the method for separating a polymer blend, the contacting in (b) is done for a period of time of at least 5 minutes, preferably in the range of from 5 minutes to 10 hours, more preferably in the range of from 5 minutes to 6 hours, more preferably in the range of from 5 minutes to 4 hours.

In some preferred embodiments of the method for separating a polymer blend, T1 is a temperature in the range of from 110 to <170° C., preferably a temperature in the range of from 110 to 165° C., more preferably a temperature in the range of from 120 to 150° C.

In some preferred embodiments of the method for separating a polymer blend, if the elastic fiber of (ii) comprises one or more polyurethane based elastic fiber(s), then T1 is a temperature in the range of from 110 to <170° C., preferably a temperature in the range of from 110 to 165° C., more preferably a temperature in the range of from 120 to 150° C.

In some preferred embodiments of the method for separating a polymer blend, if the elastic fiber of (ii) comprises one or more polyester based elastic fiber(s), then T1 is a temperature in the range of from 110 to <170° C., preferably a temperature in the range of from 130 to 165° C., more preferably a temperature in the range of from 140 to 165° C.

In some preferred embodiments of the method for separating a polymer blend, the method comprises:
(c) separating the solvent, which is enriched in dissolved elastic fiber and the residue of the polymer blend obtained in (b), preferably by a physical separation method, thereby obtaining a separated solvent, which is enriched in dissolved elastic fiber compared to the solvent provided in (a) and the residue of the polymer blend, which is depleted of said elastic fiber and comprises the polyamide or the cellulose based polymer.

In some preferred embodiments of the method for separating a polymer blend, the method comprises:
(d) optionally washing the residue of the polymer blend, which is depleted of said elastic fiber and comprises the polyamide and/or the cellulose based polymer, obtained in (c), thereby obtaining a washed residue of the polymer blend comprising the polyamide and/or the cellulose based polymer;
(e) drying the residue of the polymer blend obtained in (c) or the washed residue of the polymer blend obtained in (d), thereby obtaining a dried residue of the polymer blend comprising the polyamide and/or the cellulose based polymer.

In some preferred embodiments of the method for separating a polymer blend, for washing in step (d) a solvent selected from the group consisting of gamma-valerolactone, methanol, ethanol, propanol, isopropanol, acetonitrile, ethyl acetate, acetone, water or a mixture of two or more of these solvents, preferably a solvent comprising at least acetone, more preferably acetone, is used.

In some preferred embodiments of the method for separating a polymer blend, step (d) comprises:
(d.1) optionally washing the residue of the polymer blend obtained in (c) with a washing solution comprising a solvent comprising gamma valerolactone and removing the washing solution obtaining a pre-washed residue of the polymer blend;
(d.2) optionally washing the pre-washed residue of the polymer blend obtained in (d. 1) with a solvent selected from the group consisting of gamma-valerolactone, methanol, ethanol, propanol, isopropanol, acetonitrile, ethyl acetate, acetone, water or a mixture of two or more of these solvents, preferably a solvent comprising at least acetone, more preferably acetone, is used, thereby obtaining a washed residue of the polymer blend comprising the polyamide and/or the cellulose based polymer.

In some preferred embodiments of the method for separating a polymer blend, drying in step (e) of the polymer blend obtained in (c) or the washed residue of the polymer blend obtained in (d) is done under one or more conditions selected from the group consisting of a pressure in the range of from 1 to 1013 mbar; a temperature in the range of from 50 to 210° C., preferably in the range of from 60 to 180° C., more preferably in the range of from 80 to 150° C.; drying time in the range of from 30 minutes to 24 hours; drying in an atmosphere comprising nitrogen, preferably in an atmosphere having at least 90 volume-%, more preferably 95 volume-%, more preferably at least 98 volume-% nitrogen.

In some preferred embodiments of the method for separating a polymer blend, drying in step (e) of the polymer blend obtained in (c) or the washed residue of the polymer blend obtained in (d) is done by one or more methods selected from the group consisting of contact drying, convection drying and radiation drying.

In some preferred embodiments of the method for separating a polymer blend, the method comprises recycling the separated solvent obtained in (c) at least partially to (b), optionally after one or more work-up step(s).

In some preferred embodiments of the method for separating a polymer blend, at least one of the steps (a), (b), (c), optionally (d), optionally (d.1), optionally (d.2) and (e), preferably all these steps, are done at a pressure in the range of from 800 to 200,000 hPa.

In embodiments, where polyamide and a cellulose based polymer are present in the residue of the polymer blend, these can optionally be separated either by depolymerisation of the polyamide and subsequent monomer removal from the remaining non-depolymerized cellulose based polymer, or by dissolution of the polyamide using a suitable solvent, which does not dissolve the cellulose based polymer, or by dissolution of the cellulose based polymer by a suitable solvent, which does not dissolve the polyamide.

In some preferred embodiments of the method for separating a polymer blend, the method further comprises, in case that the residue of the polymer blend comprises a cellulose based polymer, work-up of the cellulose based polymer obtained in (d), (d.2) or (e) by applying one or more treatment(s) selected from the group consisting of:
mechanical treatment, preferably selected from the group consisting of milling, beating, shredding, tearing and mixtures of two or more of these treatments;
thermal treatment, preferably selected from the group consisting of freezing, heating or boiling and mixtures of two or more of these treatments, preferably in combination with application of excess pressure (excess pressure=pressure >1013 mbar);
incubation in an aqueous alkaline solvent, which preferably comprises water and one or more alkali, preferably sodium, salt selected from the group consisting of sodium hydroxide, sodium carbonate, sodium monochloroacetate and a mixture of two or more thereof;
incubation in an acidic solvent, preferably in one or more acid(s) selected from the group consisting of sulfuric acid, nitric acid, phosphoric acid, hydrochloric acid and formic acid;
incubation in an ionic liquid, preferably in one or more ionic liquid(s) selected from the group consisting of 1-allyl-3-methylimidazolium chloride ([AMIM]Cl), 1-butyl-3-methylimidazolium chloride ([BMIM]Cl), 1-butyl-3-methylimidazolium acetate ([BMIM][OAc]) and 1,5-diazabicyclonon-5-enium acetate ([DBNH][OAc]);
incubation in N-methylmorpholine-N-oxide (NMMO);
sonication;
radiation;
addition of an enzyme, preferably selected from the group consisting of cellulase, protease, pectinase, glucosidase, glucanotransferases, PET hydrolase (PETase) and lipase and mixtures of two or more of these enzymes, more preferably selected from the group consisting of β-1,4-exoglucanase, β-1,4-endoglucanase, β-1,4-cellobiohydrolase, β-glucosidase, pyrolase and mixtures of two or more of these enzymes; and
microbial cultivation, preferably by adding a cellulolytic bacterial or fungal strain or mixed culture.

For each of the above-listed incubation treatments in a solvent, one or more cosolute(s), preferably urea and/or polyethylene glycol (PEG), are optionally used. The treatment(s) as indicated above are used in order to change the properties of the cellulose such as crystallinity, preferably reducing cellulose crystallinity and increasing amorphous structures; degree of polymerization, preferably reducing the degree of polymerization; swell the fibers; polarity of the cellulose macromolecules; fiber orientation, preferably to induce transition of cellulose I (cellulose I_{α}) to cellulose II (cellulose I_{β}); intra- and intramolecular hydrogen bonds, electrostatic bonding and Vander-Waals forces; available surface area, preferably increase available surface area; and mois-ture content.

In some preferred embodiments of the method for separating a polymer blend, the method further comprises, in case that the residue of the polymer blend comprises polyamide, work-up of the polyamide obtained in (d), (d.2) or (e) by a method selected from the group consisting of depolymerization to oligomeric- and/or monomeric fragments thereof, mechanical recycling such as extrusion, re-granulation, compounding, and a combination of two or more of these methods.

2^{nd} Aspect—Polyamide and/or Cellulose Based Polymer

In a second aspect, the invention relates to a polyamide based polymer and/or cellulose based polymer obtained or obtainable from the method of the first aspect. All details and preferred embodiments described with respect to the first aspect apply also for the second aspect.

### 3^{rd} Aspect—Use of the Cellulose Based Polymer

A third aspect of the invention relates to the use of the cellulose based polymer of the second aspect
as combustible in a heating and power station;
as feedstock in an anaerobic digestion plant, preferably a biogas reactor;
as substrate in a wastewater treatment plant;
as input material for a biorefinery, preferably biofuel plant;
as input material in a gasification plant, preferably for production of syngas or hydrogen;
as input material in a pyrolysis reaction or pyrolysis reaction plant; and/or
as input material in a hydrothermal carbonization (HTC) process; and/or
as feedstock in a bacterial or fungal fermentation process.

### 4^{th} Aspect—Use of the Polyamide Based Polymer

A fourth aspect of the invention relates to the use of the polyamide polymer of the second aspect for preparing a textile, an automotive application, a technical fiber, or for engineering plastic.

The present invention is further illustrated by the following set of embodiments and combinations of embodiments resulting from the dependencies and back-references as indicated. In par-ticular, it is noted that in each instance where a range of embodiments is mentioned, for example in the context of a term such as “The method of any one of embodiments 1 to 4”, every embodiment in this range is meant to be explicitly disclosed for the skilled person, i.e. the wording of this term is to be understood by the skilled person as being synonymous to “The method of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.
1. A method for separating a polymer blend, wherein the polymer blend comprises
   (i) a polyamide and/or a cellulose based polymer,
   (ii) an elastic fiber;
   the method comprising:
   (a) providing the polymer blend and providing a solvent comprising gamma-valerolactone;
   (b) contacting the polymer blend with the solvent comprising gamma-valerolactone at a temperature T1 of <170° C., thereby obtaining a solvent, which is enriched in dissolved elastic fiber, and a residue of the polymer blend, which is depleted of said elastic fiber and comprises the polyamide and/or the cellulose based polymer.
2. The method for separating a polymer blend of embodiment 1, wherein the elastic fiber of (ii) is one or more polyurethane based elastic fiber(s), wherein more preferably at least 40 weight-%, more preferably at least 45 weight-%, more preferably at least 50 weight-%, more preferably at least 55 weight-%, more preferably at least 60 weight-%, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-%, of the elastic fiber are a polyurethane based elastic fiber, each based on the total weight of the elastic fiber being 100 weight-%.
3. The method for separating a polymer blend of embodiment 1, wherein the elastic fiber of (ii) comprises one or more polyester based elastic fiber(s), wherein preferably at least 40 weight-%, more preferably at least 45 weight-%, more preferably at least 50 weight-%, more preferably at least 55 weight-%, more preferably at least 60 weight-%, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-%, of the elastic fiber are a polyester based elastic fiber, each based on the total weight of the elastic fiber being 100 weight-%.
4. The method for separating a polymer blend of any one of embodiments 1 to 3, wherein the elastic fiber of (ii) is a mixture of one or more polyurethane based elastic fiber(s), and one or more polyester based elastic fiber(s) wherein preferably at least 40 weight-%, more preferably at least 45 weight-%, more preferably at least 50 weight-%, more preferably at least 55 weight-%, more preferably at least 60 weight-%, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-%, of the elastic fiber are a mixture of one or more polyurethane based elastic fiber(s), and one or more polyester based elastic fiber(s), each based on the total weight of the elastic fiber being 100 weight-%.
5. The method for separating a polymer blend of any one of embodiments 1 to 4, wherein the solvent comprising gamma-valerolactone comprises gamma-valerolactone and optionally one or more solvent(s) selected from the group consisting of water and organic solvents having a log K_{OW} in the range of from −1.6 to +1.6, preferably selected from the group consisting of water, C5 to C12 alkane, aliphatic C1 to C10 alcohol, C3 to C10 ketone, C2 to C10 cyclic ketone, HO—[C1 to C10 alkyl-O—]ₙ—H, with n being an integer in the range of from 2 to 1000, C1 to C10 alkyl-O—C3 to C10 alkyl ether, C3 to C10 cyclic ether, optionally substituted with one or more C1 to C6 alkyl group(s), C6 to C10 aromatic hydrocarbon, optionally substituted with one or more C1 to C6 alkyl group(s), C2 to C10 aliphatic ester, C8 to C11 aromatic ester, C5 to C10 cyclic carboxylic ester (lactone), C3 to C12 amide, preferably R¹R²N—C(═O)—R³, wherein R¹, R² are independently a C1 to C4 alkyl group and R³ is selected from the group consisting of C1 to C9 alkyl group, C1 to C10 ester group and C1 to C6 ether group, C3 to C6 lactame, optionally substituted with one or more substituent selected from C1 to C6 alkyl group, C1 to C6 ester group and C1 to C6 ether group, and C5 imidazolidine, optionally substituted with one or more C1 to C6 alkyl group(s), C5 to C7 imidazolidone, optionally substituted with one or more C1 to C6 alkyl group(s).
6. The method for separating a polymer blend of any one of embodiments 1 to 5, wherein the polyamide is selected from the group consisting of polyamide 6, polyamide 6.6 and mixtures of polyamide 6 and polyamide 6.6.
7. The method for separating a polymer blend of any one of embodiments 1 to 6, wherein the cellulose based polymer is selected from the group consisting of natural cellulose based polymer, synthetic cellulose based polymer and mixtures of one or more natural cellulose based polymer(s) and one or more synthetic cellulose based polymer(s), wherein a natural cellulose based polymer is preferably selected from the group consisting of cotton, cellulose, lignin, linen, viscose and mixtures of two or more thereof and wherein a synthetic cellulose based polymer is preferably viscose, wherein the cellulose based polymer preferably comprises at least cotton, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-% of the cellulose based polymer are cotton, based on the total weight of the cellulose based polymer being 100 weight-%, more preferably the cellulose based polymer is cotton.
8. The method for separating a polymer blend of any one of embodiments 1 to 7, wherein the contacting in (b) is done with a in mass based ratio polymer blend: solvent provided in (a) in the range of 1:1 to 1:100, preferably in the range of from 1:1 to 1:50, more preferably in the range of from 1:1 to 1:10.
9. The method for separating a polymer blend of any one of embodiments 1 to 8, wherein the contacting in (b) is done for a period of time of at least 5 minutes, preferably in the range of from 5 minutes to 10 hours, more preferably in the range of from 5 minutes to 6 hours, more preferably in the range of from 5 minutes to 4 hours.
10. The method for separating a polymer blend of any one of embodiments 1 to 9, wherein T1 is a temperature in the range of from 110 to <170° C., preferably a temperature in the range of from 110 to 165° C., more preferably a temperature in the range of from 120 to 150° C.
11. The method for separating a polymer blend of embodiment 10, wherein, if the elastic fiber of (ii) comprises one or more polyurethane based elastic fiber(s), then T1 is a temperature in the range of from 110 to <170° C., preferably a temperature in the range of from 110 to 165° C., more preferably a temperature in the range of from 120 to 150° C.
12. The method for separating a polymer blend of embodiment 10, wherein, if the elastic fiber of (ii) comprises one or more polyester based elastic fiber(s), then T1 is a temperature in the range of from 110 to <170° C., preferably a temperature in the range of from 130 to 165° C., more preferably a temperature in the range of from 140 to 165° C.
13. The method for separating a polymer blend of any one of embodiments 1 to 12 comprising
(c) separating the solvent, which is enriched in dissolved elastic fiber and the residue of the polymer blend obtained in (b), preferably by a physical separation method, thereby obtaining a separated solvent, which is enriched in dissolved elastic fiber compared to the solvent provided in (a) and the residue of the polymer blend, which is depleted of said elastic fiber and comprises the polyamide and/or the cellulose based polymer.
14. The method for separating a polymer blend of any one of embodiments 1 to 13 comprising
   (d) optionally washing the residue of the polymer blend, which is depleted of said elastic fiber and comprises the polyamide and/or the cellulose based polymer, obtained in (c), thereby obtaining a washed residue of the polymer blend comprising the polyamide and/or the cellulose based polymer;
   (e) drying the residue of the polymer blend obtained in (c) or the washed residue of the polymer blend obtained in (d), thereby obtaining a dried residue of the polymer blend comprising the polyamide and/or the cellulose based polymer.
15. The method for separating a polymer blend of embodiment 14, wherein for washing in step (d) a solvent selected from the group consisting of gamma-valerolactone, methanol, ethanol, propanol, isopropanol, acetonitrile, ethyl acetate, acetone, water or a mixture of two or more of these solvents, preferably a solvent comprising at least acetone, more preferably acetone, is used.
16. The method for separating a polymer blend of embodiment 14 or 15, wherein step (d) comprises
   (d.1) optionally washing the residue of the polymer blend obtained in (c) with a washing solution comprising a solvent comprising gamma valerolactone and removing the washing solution obtaining a pre-washed residue of the polymer blend;
   (d.2) optionally washing the pre-washed residue of the polymer blend obtained in (d.1) with a solvent selected from the group consisting of gamma-valerolactone, methanol, ethanol, propanol, isopropanol, acetonitrile, ethyl acetate, acetone, water or a mixture of two or more of these solvents, preferably a solvent comprising at least acetone, more preferably acetone, is used, thereby obtaining a washed residue of the polymer blend comprising the polyamide and/or the cellulose based polymer.
17. The method for separating a polymer blend of any one of embodiments 14 to 16, wherein drying in step (e) of the polymer blend obtained in (c) or the washed residue of the polymer blend obtained in (d) is done under one or more conditions selected from the group consisting of a pressure in the range of from 1 to 1013 mbar; a temperature in the range of from 50 to 210° C., preferably in the range of from 60 to 180° C., more preferably in the range of from 80 to 150° C.; drying time in the range of from 30 minutes to 24 hours; drying in an atmosphere comprising nitrogen, preferably in an atmosphere having at least 90 volume-%, more preferably 95 volume-%, more preferably at least 98 volume-% nitrogen.
18. The method for separating a polymer blend of any one of embodiments 14 to 17, wherein drying in step (e) of the polymer blend obtained in (c) or the washed residue of the polymer blend obtained in (d) is done by one or more methods selected from the group consisting of contact drying, convection drying and radiation drying.
19. The method for separating a polymer blend of any one of embodiments 1 to 18 comprising recycling the separated solvent obtained in (c) at least partially to (b), optionally after one or more work-up step(s).
20. The method for separating a polymer blend of any one of embodiments 1 to 19, wherein at least one of the steps (a), (b), (c), optionally (d), optionally (d.1), optionally (d.2) and (e), preferably all these steps, are done at a pressure in the range of from 800 to 200,000 hPa.
21. The method for separating a polymer blend of any one of embodiments 1 to 20 further comprising, in case that the residue of the polymer blend comprises a cellulose based polymer, work-up of the cellulose based polymer obtained in (d), (d.2) or (e) by applying one or more treatment(s) selected from the group consisting of:
   mechanical treatment, preferably selected from the group consisting of milling, beating, shredding, tearing and mixtures of two or more of these treatments;
   thermal treatment, preferably selected from the group consisting of freezing, heating or boiling and mixtures of two or more of these treatments, preferably in combination with application of excess pressure (excess pressure=pressure >1013 mbar);
   incubation in an aqueous alkaline solvent, which preferably comprises water and one or more alkali, preferably sodium, salt selected from the group consisting of sodium hydroxide, sodium carbonate, sodium monochloroacetate and a mixture of two or more thereof;
   incubation in an acidic solvent, preferably in one or more acid(s) selected from the group consisting of sulfuric acid, nitric acid, phosphoric acid, hydrochloric acid and formic acid;
   incubation in a ionic liquid, preferably in one or more ionic liquid(s) selected from the group consisting of 1-allyl-3-methylimidazolium chloride ([AMIM]Cl), 1-butyl-3-methylimidazolium chloride ([BMIM]Cl), 1-butyl-3-methylimidazolium acetate ([BMIM][OAc]) and 1,5-diazabicyclonon-5-enium acetate ([DBNH][OAc]);
   incubation in N-methylmorpholine-N-oxide (NMMO);
   sonication;
   radiation;
   addition of an enzyme, preferably selected from the group consisting of cellulase, protease, pectinase, glucosidase, glucanotransferases, PET hydrolase (PETase) and lipase and mixtures of two or more of these enzymes, more preferably selected from the group consisting of β-1,4-exoglucanase, β-1,4-endoglucanase, β-1,4-cellobiohydrolase, β-glucosidase, pyrolase and mixtures of two or more of these enzymes;
   microbial cultivation, preferably by adding a cellulolytic bacterial or fungal strain or mixed culture.
22. The method for separating a polymer blend of any one of embodiments 1 to 20 further comprising in case that the residue of the polymer blend comprises polyamide, work-up of the polyamide obtained in (d), (d.2) or (e) by a method selected from the group consisting of depolymerization to oligomeric- and/or monomeric fragments thereof, mechanical recycling such as extrusion, re-granulation, compounding, and a combination of two or more of these methods.
23. Polyamide and/or cellulose based polymer obtained or obtainable from the method of any one of embodiments 1 to 22.
24. Use of the cellulose based polymer of embodiment 23
   as combustible in a heating and power station;
   as feedstock in an anaerobic digestion plant, preferably a biogas reactor;
   as substrate in a wastewater treatment plant;
   as input material for a biorefinery, preferably biofuel plant;
   as input material in a gasification plant, preferably for production of syngas or hydrogen;
   as input material in a pyrolysis reaction or pyrolysis reaction plant; and/or
   as input material in a hydrothermal carbonization (HTC) process;
   as feedstock in a bacterial or fungal fermentation process.
25. Use of the polyamide polymer of embodiment 23 for preparing a textile, an automotive application, a technical fiber, or for engineering plastic.

The present invention is further illustrated by the following reference examples, comparative examples, and examples.

### EXAMPLES

### Methods

Quantitative ¹H NMR Spectroscopy (q¹H NMR):

The contents of polyamide (PA) and gamma-Valerolactone (GVL) in the samples were determined by quantitative ¹H-NMR spectroscopy. All NMR spectra were recorded at T=298.2 K on a Bruker Avance III 400 spectrometer operating at 400.33 MHz for ¹H. The spectrometer was equipped with a 5 mm z-gradient broadband observe smartprobe. ¹H 1D spectra were recorded under quantitative conditions using the zg30 pulse program with a sampling of 128 k data points, the relaxation delay D1 was chosen as 45 seconds for the solvent hexafluoro-2-propanol (HFIP) or 120 seconds for the solvent sulfuric acid-d₂ (D₂SO₄). 8 transients were summed up per spectrum. For processing in Bruker TopSpin 4.1.4 software, 128 k data points were used, an expo-nential window function with a line broadening of 0.3 Hz was applied. Automatic baseline correction with a polynomial of 3 was performed, phase correction and integration was performed manually by the user.

For the determination of PA and GVL from fabric, samples were prepared by exact weighting (Mettler-Toledo XP205DR analytical balance) of the internal standard 1,2,4,5-tetrachloro-3-nitro-benzene (Tecna) and the analyte in a suitable vial, followed by dissolution in 2 mL of HFIP. Chemical shifts were referenced to hexafluoro-2-propanol-d₂ (HFIP, δ(HFIP)=4.25 ppm). For the determination of PA and GVL from elastic fibers, samples were prepared by exact weighting (Mettler-Toledo XP205DR analytical balance) of the internal standard dimethylmalo-nic acid (DMMS) and the analyte in a suitable vial, followed by dissolution in 2 ml D₂SO₄. In all cases, the samples were transferred into 5 mm NMR tubes for measurement. Deuterated solvents HFIP was purchased from Euriso-Top GmbH. D₂SO₄, Tecna and DMMS (certified internal standards) were purchased from Sigma-Aldrich. All solvents and internal standards were used as received.

The content of test item was calculated by using the following equation:

$$w = \frac{{E}_{S t} \cdot {I}_{K} \cdot {M}_{K} \cdot {A}_{S t} \cdot {R}_{S t}}{{E}_{P} \cdot {I}_{S t} \cdot {M}_{S t} \cdot {A}_{K}}$$

In this equation: w=mass fraction of the analyte in the sample [g/100 g], Iₖ=peak intensity of the analyte, I_{St}=peak intensity of the standard, E_{P}=sample mass [g], E_{St}=mass of the standard [g], Ak=protons/molecule of analyte, Ast=protons/molecule of the standard, MK=molecular weight of the analyte [g/mol], Mst=molecular weight of the standard [g/mol], and Rst=purity of the standard [g/100 g].

For quantification triplicate determinations were carried out.

Evaluation of PA was performed by using 1 proton/molecule of the internal standard Tecna (at about 7.6 ppm) and 2 selected protons/molecule of the analyte PA (at about 2.2 ppm). Evaluation of GVL was performed by using 6 protons/molecule of the internal standard DMMS (at about 1.80 ppm) and 3 protons/molecule of the analyte GVL (at about 1.7 ppm).

### Infrared Spectroscopy (IR):

FTIR-ATR spectra were obtained by FTIR spectrometers equipped with ATR units (Thermo Ni-colet 6700+diamond ATR unit (PIKE GladiATR) and Thermo iS10+ZnSe ATR unit (Smart Performer)).

For measurement the samples were placed directly onto the ATR crystal without further preparation and were fixed with the unit's stamp. All measurements were performed at room temperature (25° C.) using 32 scans and a resolution of 4 cm⁻¹.

### Chemicals

| | |
|---|---|
| (Chemical) name | Abbreviation |

Polymeric materials

| | |
|---|---|
| Polyamide | PA |
| Cotton | — |

solvents

| | |
|---|---|
| gamma-valerolactone | GVL |
| (5-methyl oxolan-2-one) | |
| water | — |
| acetone | — |

### Reference Example 1: General Procedure for Separation of Elastic Fiber from Cotton or PA

Polymeric material (in any colour) was cut/shredded into pieces and placed in a reaction vessel (e.g. flask, tube, reaction vessel). Degassed GVL was added (in mass-based ratio polymeric material: GVL 1:1 to 1:100, preferred 1:1-1:10) and the mixture was heated by use of a suitable heating system (e.g. oil bath, heating blocks, mini-plant vessels) to 110-170° C. After 0.1-6 h the mixture was filtered, whereby GVL enriched in elastic fiber and cellulose based pieces or PA pieces were obtained and the polymeric material pieces were washed with a small amount of GVL. For an easy removal of GVL and a faster drying process of the elastic fiber-free cellulose based or PA pieces, small amounts of acetone can be used in a second washing step. The thus obtained polymeric material pieces were dried (for example in a vacuum compartment dryer).

The samples were analyzed before treatment ((colored) polymeric material, Table 1-4) and after the final drying step (polymeric material depleted of elastic fiber, Table 1-4) in that in case of PA/elastic fiber separation a quantitative ¹H-NMR was measured to determine the PA content and IR spectroscopy to show the change of characteristic peaks before and after treatment and in comparison to known spectra for polyamide 6, polyamide 6.6 and—elastic fiber based on polyurethane and polyether(s). In case of cellulose based polymer/elastic fiber, separation was proven by IR spectroscopy to show the change of characteristic peaks before and after treatment and in comparison to known spectra for cotton and elastic fiber based on polyurethane and polyether(s).

### For all Procedures Applied the Following:

For recycling of the used solvent GVL, the filtrate was distilled (50-200° C., 2 hPa to ambient pressure, preferred 70-110° C., 5-30 hPa) to obtain GVL having a purity according to GC of >99%. For GLV, the Hazen color index was determined before treatment and after distillation.

### Example 1: Cotton/Elastic Fiber Separation

Material from a white top comprising elastic fiber and cotton was treated as described in Reference Example 1, wherein type of polymeric material and experimental conditions, as well as results are indicated in Table 1. The samples were analysed before treatment ((colored) polymeric material, Table 1) and after the final drying step (polymeric material depleted of elastic fiber, Table 1) in that weight was determined and IR spectroscopy was performed to demonstrate the change of peaks before and after separation and in comparison with known spectra for cotton and elastic fiber based on polyurethane and polyether(s).

TABLE 1
Experimental results for Cotton/elastic fiber separation

| | | mass |
|---|---|---|
| | | weighted with |
| | | balance |
| Before | White top | 10 g |
| treatment | (starting | |
| | material) | |

| | |
|---|---|
| Process | 10 g/100 g = 1:10 |
| conditions | (PA + elastic fiber: GVL) |
| | Procedure 1 |
| | 4 h, 150° C. |

| | | |
|---|---|---|
| After | polymeric | 8.2 g |
| treatment | material | reobtained |
| | pieces after | Cotton |
| | drying | |

It was shown based on IR spectroscopy that:
a) Kind of elastic fiber: The elastic fiber was based on polyurethane and polyether(s).
b) IR description of material before treatment:

The material before treatment showed cotton with additional peaks at 1730, 1707, 1637, 1592 and 1535 cm⁻¹. The additional peaks result from elastic fiber based on polyurethane and poly-ether(s).
c) IR description of material after treatment:

The material after treatment showed only cotton without the additional peaks. This result clearly showed a full separation of the elastic fiber based on polyurethane and polyether(s) from cotton.

The IR spectra before treatment and after treatment are shown in in comparison in FIG. 1.

### Example 2: PA/Elastic Fiber Separation

Material from beach fashion comprising elastic fiber and polyamide was treated as described in Reference Example 1, wherein type of polymeric material and experimental conditions, as well as results are indicated in Table 2. The samples were analysed before treatment ((colored) polymeric material, Table 2) and after the final drying step (polymeric material depleted of elastic fiber, Table 2) in that weight was determined, a quantitative ¹H-NMR was measured to determine the polyamide (PA) content before and after the separation and IR spectroscopy was performed to demonstrate the change of peaks before and after separation and in comparison with known spectra for polyamide.

TABLE 2
Experimental results for PA/elastic
fiber separation from beach fashion

| | | | NMR |
|---|---|---|---|
| | | | PA content by |
| | | mass | quantitative |
| | | weighted with | ¹H-NMR |
| | | balance | [g/100 g] |
| Before | Black, pink, | 10 g | 83.0 ± 1.0 |
| treatment | blue, yellow, | | |
| | white beach | | |
| | fashion (starting | | |
| | material) | | |
| Process | 10 g/100 g = 1:10 | | |
| conditions | (PA + Spandex: GVL) | | |
| | Procedure 1 | | |
| | 4 h, 150° C. | | |
| After | polymeric | 8.3 g | 95.7 ± 1.0 |
| treatment | material | reobtained | |
| | pieces after | PA | |
| | drying | | |

It was shown that the starting material consisted of 83 g Polyamide per 100 g of material. 10 g of this material were treated according to the procedure of Reference Example 1 and 8.3 g of elastic fiber-free polyamide were reobtained. The NMR clearly showed no peaks indicating the elastic-fiber but 95.7 g polyamide. This result showed, that the elastic-fiber could be completely removed from the PA/elastic fiber mixed-coloured beach fashion.

Based on IR spectroscopy, it was shown that:
a) Kind of elastic fiber:

The elastic fiber was based on polyurethane and polyether(s).
b) IR description of material before treatment:

The spectrum measured before treatment showed a mixture of polyamide 6 (PA6) and an elastic fiber based on polyurethane and polyether(s) (with its characteristic signals at 1730, 1708 and 1104 cm⁻¹).
c) IR description of reobtained PA material:

The IR spectrum measured of the reobtained material showed that it only consisted of PA 6. No additional peaks were found that belonged to the elastic fiber.

A comparison of IR spectra of reobtained PA after separation (treatment) and of Polyamide 6 (fresh, for comparison purpose) is shown in FIG. 2, a comparison of IR spectra before and after treatment is shown in FIG. 3.

Therefrom, it was clearly visible that the elastic fiber was completely removed after the treatment and it was shown that the elastic fiber had been based on polyurethane and polyether(s).

### Example 3: PA/Elastic Fiber Separation from Tights

Material from black tights comprising elastic fiber and polyamide was treated as described in Reference Example 1, wherein type of polymeric material and experimental conditions, as well as results are indicated in Table 3. The samples were analysed before treatment ((colored) polymeric material, Table 3) and after the final drying step (polymeric material depleted of elastic fiber, Table 3) in that weight was determined, a quantitative ¹H-NMR was measured to determine the polyamide (PA) content before and after the separation and IR spectroscopy was performed to demonstrate the change of peaks before and after separation and in comparison with known spectra for polyamide.

TABLE 3
Experimental results for PA/elastic fiber separation from tights

| | | | NMR |
|---|---|---|---|
| | | | PA content by |
| | | mass | quantitative |
| | | weighted with | ¹H-NMR |
| | | balance | [g/100 g] |
| Before | Black tights | 150 g | — |
| treatment | (starting | | |
| | material) | | |
| Process | 150 g/1500 g = 1:10 | | |
| conditions | (PA/elastic fiber: GVL) | | |
| | Procedure 1 | | |
| | 4 h, 150° C. | | |
| After | polymeric | 89.6 g | Reobtained PA: |
| treatment | material | reobtained PA | 90.9 ± 1.0 |
| | pieces after | 58 g of | Reobtained solid |
| | drying | reobtained solid | after distilla- |
| | | after distilla- | tion of GVL: no |
| | | tion of GVL | PA detected |

Further analysis of the extracted textile:

The extracted textile material was evaluated via ¹H-NMR, which confirmed the complete removal of elastic fiber from the PA6.6. After drying in vacuo at 80° C. for 1 day, the material was processed in a DSM mini compounder (100 rpm, 290° C., extrusion time 3 minutes). The material was readily processable. To evaluate the mechanical properties of the material, tensile specimens were made and tested according to ISO 527-2:2012. The specimens exhibit higher E-modules of 3992 MPa than PA 66 (2315 MPa), tensile stress at break (73 MPa) and nominal tensile strain at break (202%) are comparable to similar made specimen made of PA 66. To sum up, the extraction method enables thermoplastic processing of the material with retention of key mechanical properties.

The GVL fraction which contained the remaining of the elastic fiber was subjected to distillation and the remaining residue was dried under air, thereby, a solid was obtained which was called the reobtained elastic fiber fraction. In said reobtained elastic fiber fraction, residual amounts of GVL were detected.

Quantitative ¹H-NMR of both fractions (reobtained polyamide and reobtained solid after distillation of GVL) clearly showed that a full separation of elastic fiber and polyamide could be achieved.

Based on IR spectroscopy it could be shown that:
a) Kind of elastic fiber:

The elastic fiber was a mixture of polyurethane with polyester(s) and polyurethane with poly-ether(s) and polyacrylonitrile.
b) IR description of reobtained PA material:

The IR spectrum measured of the reobtained material after treatment showed that it only consisted of PA 6.6. No additional peaks were found that belonged to the elastic fiber. IR spectra for direct comparison of reobtained PA after separation (treatment, IR spectrum taken twice) and Polyamide 6.6 (fresh, for comparison) are shown in FIG. 4:
c) IR description of reobtained elastic fiber:

The IR spectrum of the reobtained elastic fiber showed that it consisted of a mixture of polyester, polyurethane and polyacrylonitrile. The material showed no signals for PA 6.6. The material showed residual amounts of the solvent GVL. IR spectra for direct comparison of both fractions (reobtained polyamide and reobtained elastic fiber) are shown in FIG. 5. IR spectra in comparison of reobtained PA after treatment, reobtained elastic fiber, and GLV are shown in FIG. 6.

### Example 4: Cotton/Linen/Viscose/Sorona

The material (according to the producer) consisted of 15 weight-% cotton, 45 weight-% linen, 22 weight-% viscose and 18 weight-% of Sorona (PTT-based elastic fiber) and was treated as described in Reference Example 1, wherein experimental conditions, as well as results are indicated in Table 4. The samples were analysed before treatment ((colored) polymeric material, Table 4) and after the final drying step (polymeric material depleted of Sorona, Table 4) in that weight was determined.

TABLE 4
Experimental results for Sorona separation
from Cotton/Linen/Viscose separation

| | | mass |
|---|---|---|
| | | weighted with |
| | | balance |
| Before | Blue fabric | 10 g |
| treatment | (starting | |
| | material) | |

| | |
|---|---|
| Process | 10 g/100 g = 1:10 |
| conditions | (Cotton/Linen/ |
| | Viscose/Sorona: GVL) |
| | Procedure 1 |
| | 4 h, 150° C. |

| | | |
|---|---|---|
| After | polymeric | 8.8 g reobtained Cotton |
| treatment | material | 1.2 g reobtained solid |
| | pieces after | after distillation of |
| | drying | GVL |

According to the experimental results, the material consisted of 12 weight-% Sorona, which could be removed with this process.

### Comparative Examples (CE) 1 to 3: Separation Using Known Solvents

The comparative examples 1 to 4 were carried out as described in Reference Example 1 for the black tights (of example 3) with the difference that instead of GVL another solvent selected from ethanol (EtOH, Comparative Example 1, Table 5), cyclohexanone (Comparative Example 2, Table 6) and ethyl lactate (Comparative Example 1, Table 7) was used. Additionally, when using EtOH (Comparative Example 1) the separation was done at 70° C. due to boiling point.

TABLE 5
Experimental results for comparative Example 1 (EtOH)

| | | weighted with |
|---|---|---|
| | | balance |
| Before | Black tights | 10 g |
| treatment | (starting | |
| | material) | |

| | |
|---|---|
| Process | 10 g/100 g = 1:10 |
| conditions | (PA/elastic fiber: EtOH) |
| | Procedure 1 |
| | 4 h, 70° C. |

| | | |
|---|---|---|
| After | polymeric | 9.6 g of |
| treatment | material | undissolved |
| | pieces after | material |
| | drying | |

TABLE 6
Experimental results for comparative Example 2 (Cyclohexanone)

| | | weighted with |
|---|---|---|
| | | balance |
| Before | Black tights | 10 g |
| treatment | (starting | |
| | material) | |

| | |
|---|---|
| Process | 10 g/100 g = 1:10 |
| conditions | (PA/elastic fiber: Cyclohexanone) |
| | Procedure 1 |
| | 4 h, 150° C. |

| | | |
|---|---|---|
| After | polymeric | 8.5 g of |
| treatment | material | undissolved |
| | pieces after | material |
| | drying | |

TABLE 7
Experimental results for comparative Example 3 (Ethyl lactate)

| | | weighted with |
|---|---|---|
| | | balance |
| Before | Black tights | 10 g |
| treatment | (starting | |
| | material) | |

| | |
|---|---|
| Process | 10 g/100 g = 1:10 |
| conditions | (PA/elastic fiber: Ethyl lactate) |
| | Procedure 1 |
| | 4 h, 150° C. |

| | | |
|---|---|---|
| After | polymeric | 9.4 g of |
| treatment | material | undissolved |
| | pieces after | material |
| | drying | |

### Mass Balance Analysis:

For the comparative examples the same material as for Example 3 was used (black tights, mixture of polyamide and an elastic fiber comprising polyurethane with polyester(s), polyurethane with polyether(s) and polyacrylonitrile. After treatment with GVL in Example 3, a full separation could be shown and according to these results the starting material consisted of 39 weight-% of the elastic fiber.

According to the weighed mass of before and after treatment when applying EtOH, cyclohexanone and ethyl lactate basically no elastic fiber was removed. This was also in accordance to IR spectroscopy:

### 1) IR Description of Reobtained Material—EtOH

The reobtained material showed the typical peaks for PA 6.6 with additional peaks at 1730 cm⁻¹ (polyurethane) and at 2240 cm⁻¹ (acrylonitrile). This clearly showed, that if at all the separation of polyamide and elastic fiber was by far not complete.

### 2) IR Description of Reobtained Material—Cyclohexanone

The reobtained material showed the typical peaks for PA 6.6 with additional peaks at 1733 cm⁻¹ (polyurethane) and at 2240 cm⁻¹ (acrylonitrile). This clearly showed, that if at all the separation of polyamide and elastic fiber was by far not complete.

### 3) IR Description of Reobtained Material—Ethyl Lactate

The reobtained material showed the typical peaks for PA 6.6 with additional peaks at 1733 cm⁻¹ (polyurethane) and at 2240 cm⁻¹ (acrylonitrile). This clearly showed, that if at all the separation of polyamide and elastic fiber was by far not complete.

IR Spectra in comparison of Comparative Examples 1-3 and Example 3-PA fraction are shown in FIG. 7.

### SHORT DESCRIPTION OF THE FIGURES

FIG. 1 shows a comparison of the IR spectra of the material before treatment and of the reobtained material after treatment according to Example 1.

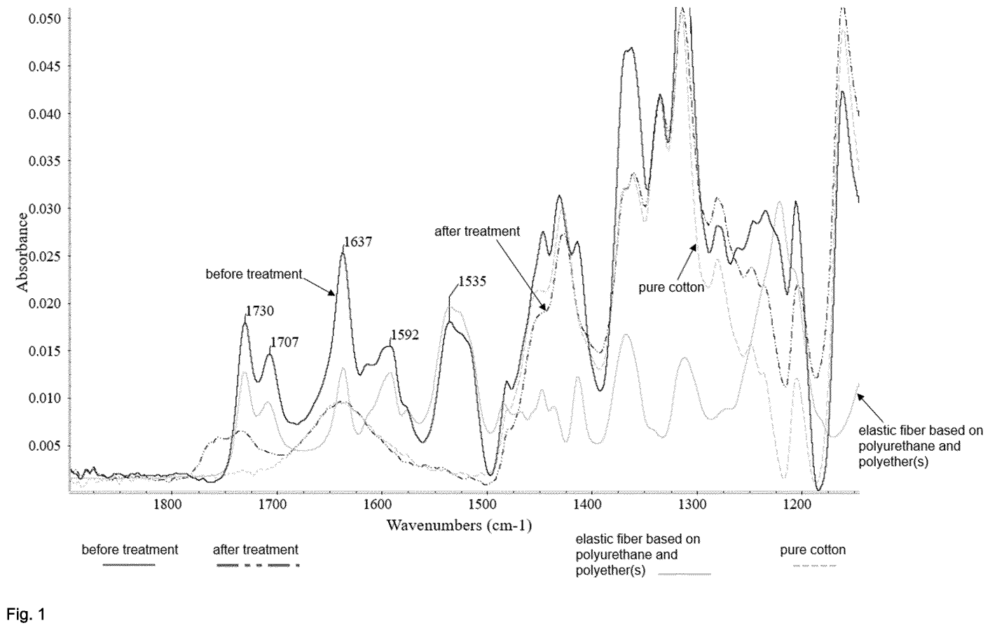

FIG. 2 shows a comparison of IR spectra of reobtained PA after separation (treatment) and of Polyamide 6 (fresh, for comparison purpose) of Example 2.

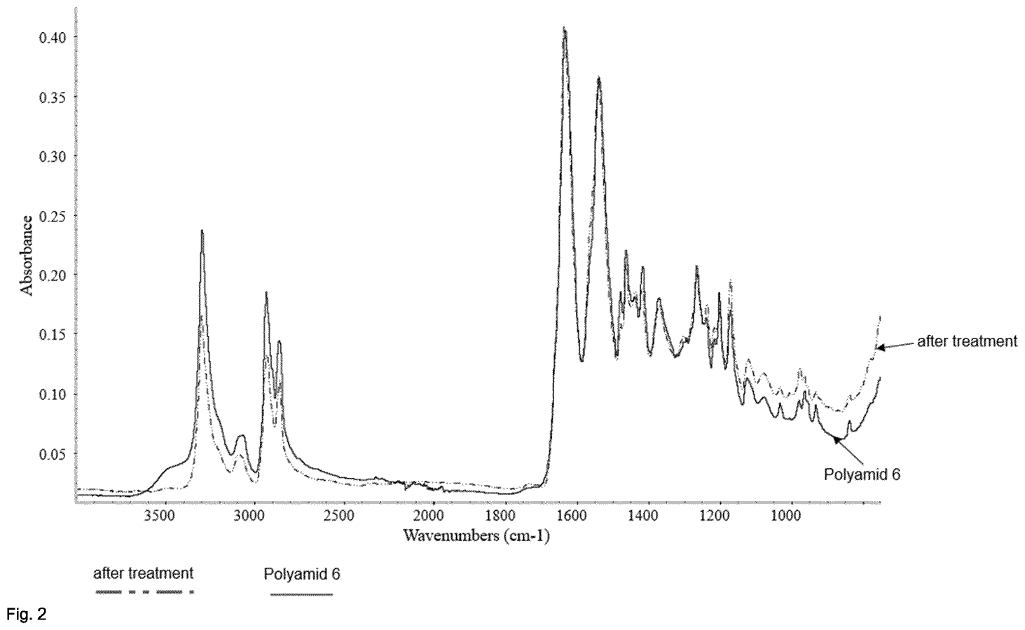

FIG. 3. shows a comparison of IR spectra of the material before treatment and of the reobtained material (PA) after treatment of Example 2.

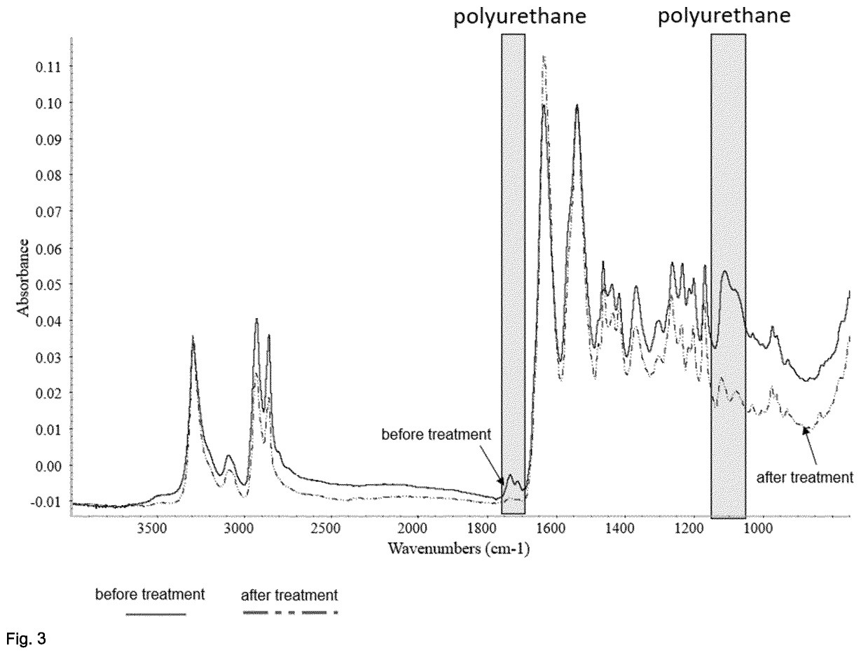

FIG. 4 shows a comparison of IR spectra of reobtained PA after separation (treatment, IR spectrum taken twice) and Polyamide 6.6 (fresh, for comparison) of Example 3.

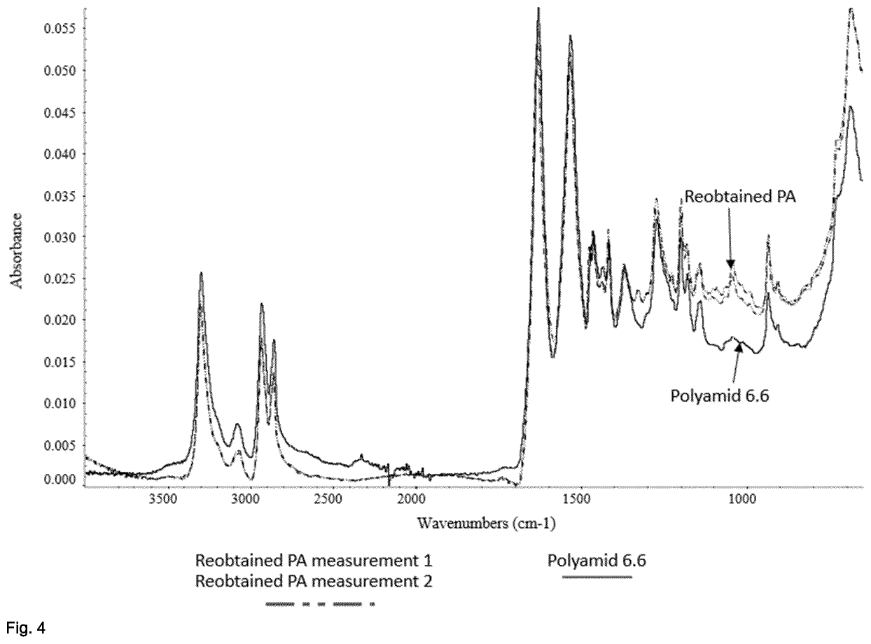

FIG. 5 shows a comparison of IR spectra of reobtained polyamide and reobtained elastic fiber, both after treatment of Example 3.

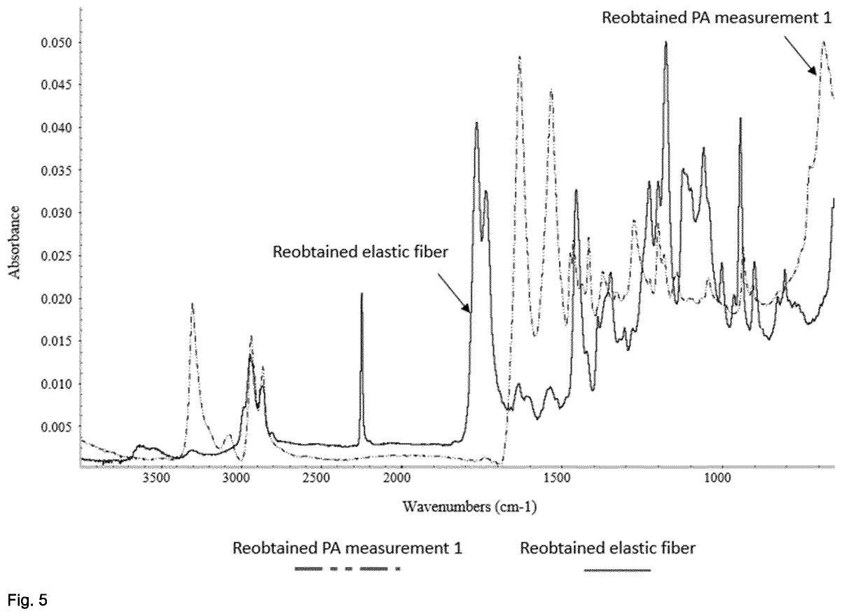

FIG. 6 shows a comparison of IR spectra of reobtained PA after treatment, reobtained elastic fiber, and GLV of Example 3.

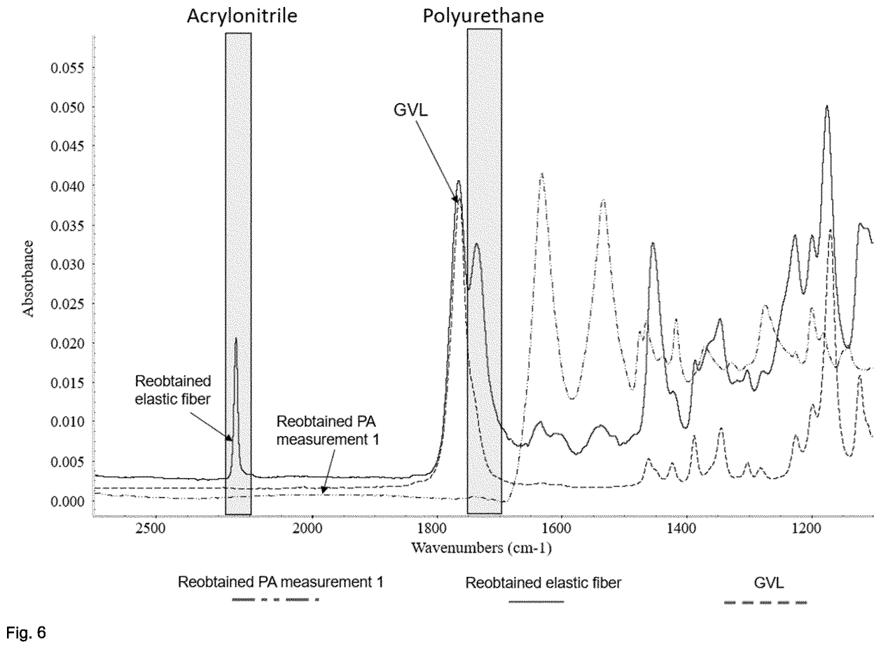

FIG. 7 shows a comparison of IR spectra of Comparative Examples 1-3 and Example 3-PA fraction.

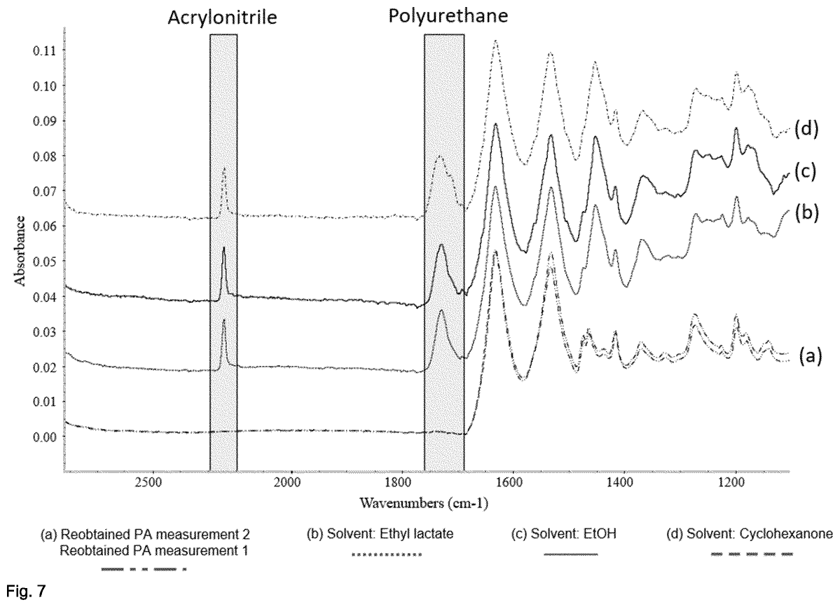

### CITED LITERATURE

WO 2016/12755 A1
Wenjun Chen, Yuechao Yang, Xue Lan, Baolong Zhang, Xiaogang Zhang and Tiancheng Mu in Green Chem., 2021, 23, 4065
WO 2013/032408 A1
WO 2022/115602 A1

1. A method for separating a polymer blend, wherein the polymer blend comprises
(i) a polyamide and/or a cellulose based polymer, and
(ii) an elastic fiber, wherein at least 90 weight-% of the elastic fiber are a polyurethane based elastic fiber, based on the total weight of the elastic fiber being 100 weight-%;
the method comprising:
(a) providing the polymer blend and providing a solvent comprising gamma-valerolactone; and
(b) contacting the polymer blend with the solvent comprising gamma-valerolactone at a temperature T1 of <170° C., thereby obtaining a solvent, which is enriched in dissolved elastic fiber, and a residue of the polymer blend, which is depleted of said elastic fiber and comprises the polyamide and/or the cellulose based polymer.

2. The method for separating a polymer blend of claim 1, wherein the elastic fiber of (ii) comprises one or more polyurethane based elastic fiber(s).

3. The method for separating a polymer blend of claim 1, wherein at least 95 weight-%, of the elastic fiber are a polyurethane based elastic fiber, each based on the total weight of the elastic fiber being 100 weight-%.

4. The method for separating a polymer blend of claim 1, wherein the solvent comprising gamma-valerolactone comprises gamma-valerolactone and optionally one or more solvent(s) selected from the group consisting of water and organic solvents having a log K_{OW} in the range of from −1.6 to +1.6.

5. The method for separating a polymer blend of claim 1, wherein the polyamide is selected from the group consisting of polyamide 6, polyamide 6.6 and mixtures of polyamide 6 and polyamide 6.6.

6. The method for separating a polymer blend of claim 1, wherein the cellulose based polymer is selected from the group consisting of a natural cellulose based polymer, a synthetic cellulose based polymer and mixtures of one or more natural cellulose based polymer(s) and one or more synthetic cellulose based polymer(s).

7. The method for separating a polymer blend of claim 1, wherein T1 is a temperature in the range of from 110 to <170° C., if the elastic fiber of (ii) comprises one or more polyurethane based elastic fiber(s).

8. The method for separating a polymer blend of claim 1, further comprising:
(c) separating the solvent, which is enriched in dissolved elastic fiber and the residue of the polymer blend obtained in (b), thereby obtaining a separated solvent, which is enriched in dissolved elastic fiber compared to the solvent provided in (a) and the residue of the polymer blend, which is depleted of said elastic fiber and comprises the polyamide and/or the cellulose based polymer.

9. The method for separating a polymer blend of claim 1, further comprising:
(d) optionally washing the residue of the polymer blend, which is depleted of said elastic fiber and comprises the polyamide and/or the cellulose based polymer, obtained in (c), thereby obtaining a washed residue of the polymer blend comprising the polyamide and/or the cellulose based polymer; and
(e) drying the residue of the polymer blend obtained in (c) or the washed residue of the polymer blend obtained in (d), thereby obtaining a dried residue of the polymer blend comprising the polyamide and/or the cellulose based polymer.

10. The method for separating a polymer blend of claim 9, wherein step (d) comprises:
(d.1) optionally washing the residue of the polymer blend obtained in (c) with a washing solution comprising a solvent comprising gamma valerolactone and removing the washing solution obtaining a pre-washed residue of the polymer blend; and
(d.2) optionally washing the pre-washed residue of the polymer blend obtained in (d.1) with a solvent selected from the group consisting of gamma-valerolactone, methanol, ethanol, propanol, isopropanol, acetonitrile, ethyl acetate, acetone, water and a mixture of two or more of these solvents, thereby obtaining a washed residue of the polymer blend comprising the polyamide and/or the cellulose based polymer.

11. The method for separating a polymer blend of claim 1, further comprising, in case that the residue of the polymer blend comprises a cellulose based polymer, work-up of the cellulose based polymer obtained in (d), (d.2) or (e) by applying one or more treatment(s) selected from the group consisting of:
mechanical treatment;
thermal treatment;
incubation in an aqueous alkaline solvent;
incubation in an acidic solvent;
incubation in an ionic liquid;
incubation in N-methylmorpholine-N-oxide (NMMO);
sonication;
radiation;
addition of an enzyme; and
microbial cultivation.

12. The method for separating a polymer blend of claim 1, further comprising, in case that the residue of the polymer blend comprises polyamide, work-up of the polyamide obtained in (d), (d.2) or (e) by a method selected from the group consisting of depolymerization to oligomeric- and/or monomeric fragments thereof, mechanical recycling, re-granulation, compounding, and a combination of two or more of these methods.

13. A polyamide and/or cellulose based polymer obtained from the method of claim 1.

14. A method of using the polyamide and/or cellulose based polymer of claim 13, the method comprising using the polyamide and/or cellulose based polymer:
as combustible in a heating and power station;
as feedstock in an anaerobic digestion plant;
as substrate in a wastewater treatment plant;
as input material for a biorefinery;
as input material in a gasification plant;
as input material in a pyrolysis reaction or pyrolysis reaction plant;
as input material in a hydrothermal carbonization (HTC) process; and/or
as feedstock in a bacterial or fungal fermentation process.

15. A method of using the polyamide and/or cellulose polymer of claim 13, the method comprising using the polyamide and/or cellulose polymer for preparing a textile, an automotive application, a technical fiber, or for engineering plastic.

16. The method for separating a polymer blend of claim 1, wherein the elastic fiber of (ii) comprises a (block) copolymer based on polyurethane.

17. The method for separating a polymer blend of claim 6, wherein the natural cellulose based polymer is selected from the group consisting of cotton, cellulose, lignin, linen, viscose and mixtures of two or more thereof.

18. The method for separating a polymer blend of claim 6, wherein the synthetic cellulose based polymer is viscose.

19. The method for separating a polymer blend of claim 6, wherein the cellulose based polymer comprises at least cotton.

20. The method for separating a polymer blend of claim 1, wherein T1 is a temperature in the range of from 110 to <170° C., if the elastic fiber of (ii) comprises one or more polyester based elastic fiber(s).
